(19) United States
(12) Patent Application Publication
(10) Pub. No.: US 2022/0237690 A1
(43) Pub. Date: Jul. 28, 2022

(54) INFORMATION PROCESSING DEVICE, INFORMATION PROCESSING METHOD AND RECORDING MEDIUM

(71) Applicant: HONDA MOTOR CO., LTD., Tokyo (JP)

(72) Inventor: Haruki Nakayama, Tokyo (JP)

(21) Appl. No.: 17/565,083

(22) Filed: Dec. 29, 2021

(30) Foreign Application Priority Data
Jan. 26, 2021 (JP) 2021-010165

(51) Int. Cl. G06Q 30/06; G06F 9/451

(52) U.S. Cl. CPC G06Q 30/0645; G06F 9/451

(57) ABSTRACT

An information processing device includes: a user action recognition part configured to recognize an action of a user of a moving body; an information presentation part configured to present a user interface which registers property of the user as a lendable state, to the user, in a case where a specific action corresponding to either of an action with which it is estimated that the user is to start moving by the moving body or an action with which it is estimated that the user is to get out of the moving body is recognized by the user action recognition part; a communication unit configured to communicate with a management server; and an information transmission part configured to transmit registration information which registers the property as the lendable state by the communication unit in the case where registration is instructed by the user interface.

### INCORPORATION BY REFERENCE

The present application claims priority under 35 U.S.C. § 119 to Japanese Patent Application No. 2021-010165 filed on Jan. 26, 2020. The content of the application is incorporated herein by reference in its entirety.

### BACKGROUND OF THE INVENTION

### Field of the Invention

The present invention relates to an information processing device, an information processing method and a recording medium.

### Description of the Related Art

Conventionally, a method of mediating rental between a user who owns a property and a user who wants to rent the property has been known. Japanese Patent Laid-Open No. 2002-099762 discloses an automobile rental mediation system in which a member to be a lender provides an automobile and a member to be a borrower utilizes the automobile as a rental car. In the system, the member to be the lender operates a terminal and inputs information such as the desired date, time and location of lending, the desired date, time and location of return, the type, year, mileage and automobile inspection year of the automobile to be provided, a desired remuneration and member identification information to make an application.

As in the system described in Japanese Patent Laid-Open No. 2002-099762, conventionally, there has been a problem that, in order for an owner of property to lend the property, it is needed to go through a procedure for determining a lending period and inputting detailed information beforehand, and it is troublesome.

The present invention is implemented in consideration of such a background and an object is to simplify a procedure of an owner of property for lending the property and improve convenience.

### SUMMARY OF THE INVENTION

A first aspect for achieving the object described above is an information processing device including: a user action recognition part configured to recognize an action of a user of a moving body; an information presentation part configured to present a setting part which registers property of the user as a lendable state, to the user, in a case where a specific action corresponding to either of an action with which it is estimated that the user is to start moving by the moving body or an action with which it is estimated that the user is to get out of the moving body is recognized by the user action recognition part; a communication part configured to communicate with a management device; and an information transmission part configured to transmit registration information which registers the property as the lendable state by the communication part in the case where registration is instructed by the setting part.

In the information processing device, the information presentation part may present time to put the property in the lendable state when presenting the setting part.

In the information processing device, the information presentation part may present a plurality of candidates of the time to put the property in the lendable state when presenting the setting part.

The information processing device may include a position information acquisition part configured to acquire a position of the moving body, and the information presentation part may present the setting part in the case where the position of the moving body acquired by the position information acquisition part is a specific position set beforehand.

The information processing device may include: a position information acquisition part configured to acquire a position of the moving body; and a lending information acquisition part configured to acquire information regarding a lending situation of property of a same kind as the property based on the position of the moving body from the management device, and the information presentation part may present the time to put the property in the lendable state based on the information acquired by the lending information acquisition part, when presenting the setting part.

In the information processing device, the user action recognition part may recognize the action of the user based on at least one of a power supply state of apparatuses loaded in the moving body, an open/closed state of a door provided on the moving body, a lock state of the door and a seating state on a seat of the moving body.

In the information processing device, the property may be the moving body, and the information transmission part may transmit the registration information and information indicating a residual amount of fuel that the moving body has by the communication part.

In the information processing device, the property may be the moving body, the information processing device may include a photographing part configured to photograph the moving body, and the information transmission part may transmit the registration information and a photographed image of the photographing part by the communication part.

In the information processing device, the information transmission part may transmit cancellation information which cancels registration of the property as the lendable state by the communication part in the case where the property registered as the lendable state is the moving body and the moving body starts moving while being registered as the lendable state.

In the information processing device, the information presentation part may present the setting part by a display part provided in the moving body, and the information transmission part may transmit the registration information by the communication part based on an operation to the setting part displayed at the display part.

A second aspect for achieving the object described above is an information processing method that recognizes an action of a user of a moving body, presents a setting part which registers property of the user as a lendable state, to the user, in a case where a specific action corresponding to either of an action with which it is estimated that the user is to start moving by the moving body or an action with which it is estimated that the user is to get out of the moving body is recognized, and transmits registration information which registers the property as the lendable state to a management device in the case where registration is instructed by the setting part.

A third aspect for achieving the object described above is a non-transitory computer-readable recording medium having a program executable by a computer that controls an information processing device including a communication part recorded thereon, the recording medium having the program for, by the computer, recognizing an action of a user of a moving body, presenting a setting part which registers property of the user as a lendable state, to the user, in a case where a specific action corresponding to either of an action with which it is estimated that the user is to start moving by the moving body or an action with which it is estimated that the user is to get out of the moving body is recognized, and transmitting registration information which registers the property as the lendable state to a management device by the communication part in the case where registration is instructed by the setting part, recorded thereon.

According to the configuration described above, since a user can easily register property, a procedure regarding lending of the property can be simplified and convenience can be improved.

### BRIEF DESCRIPTION OF THE DRAWINGS

FIG. 1 is an explanatory drawing illustrating an outline of an information processing system;

FIG. 2 is a schematic diagram of data stored by a management device;

FIG. 3 is a block diagram of an information processing device;

FIG. 4 is a sequence diagram illustrating an operation of the information processing device and the management device;

FIG. 5 is a diagram illustrating an example of a screen displayed by the information processing device;

FIG. 6 is a diagram illustrating an example of the screen displayed by the information processing device;

FIG. 7 is a sequence diagram illustrating the operation of the information processing device and the management device; and

FIG. 8 is a sequence diagram illustrating the operation of the information processing device and the management device.

### DETAILED DESCRIPTION OF THE PREFERRED EMBODIMENTS

### 1. Outline of Information Processing System

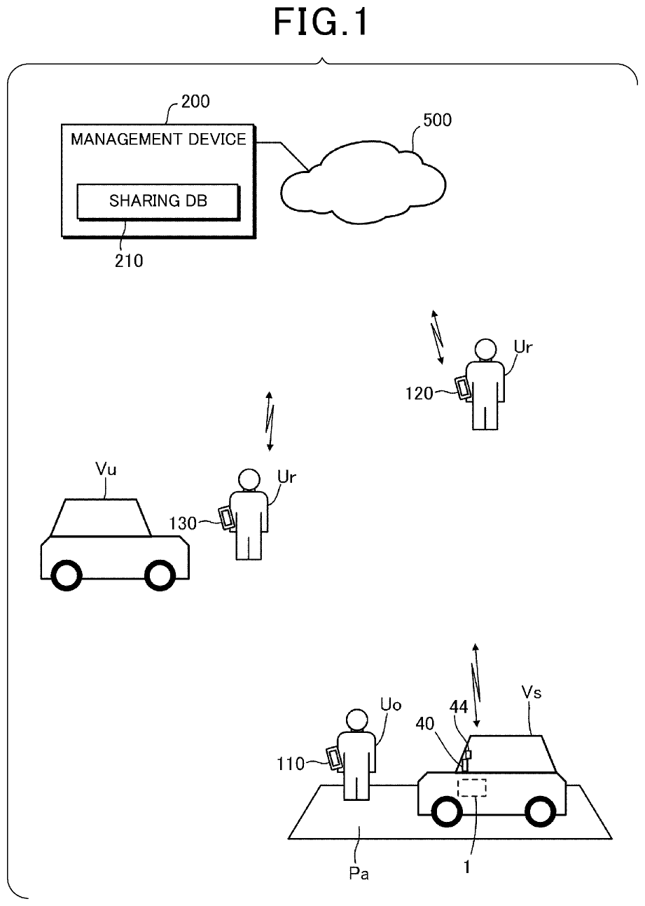

FIG. 1 is an explanatory drawing illustrating the outline of the information processing system including an information processing device 1 of the present embodiment and a management device 200. In the present embodiment, as an example of a moving body, a vehicle Vs which is a four-wheel automobile is illustrated.

The information processing system of the present embodiment makes it possible for an owner Uo to lend property for time desired by the owner Uo. An example of the property to be lent by the owner Uo is the vehicle Vs owned by the owner Uo and a parking location Pa can be also lent. Here, the property may be movable property or immovable property, and may be a building including a house, some space inside the building and a garage or the like. Hereinafter, an example that the owner Uo lends the vehicle Vs to a user Ur and an example that the owner Uo lends the parking location Pa as a parking location of the vehicle Vs will be described as an example.

Devices indicated by signs 110, 120 and 130 in the figure are portable computers called mobile devices or handheld computers, and are smartphones or tablet type computers for example. The portable devices 110, 120 and 130 are the devices used by the owner Uo and the user Ur who are users of the information processing system.

In the vehicle Vs, the information processing device 1 is loaded. The information processing device 1 may be a device fixedly installed in the vehicle Vs, or may be a device temporarily installed in the vehicle Vs. The information processing device 1 of the present embodiment includes a touch panel 40 and a camera 44 loaded in the vehicle Vs, and executes communication with the management device 200 via a communication network 500.

The management device 200 configuring the information communication system is connected to the communication network 500 and executes data communication with the information processing device 1. The communication network 500 is a data communication network, and the examples are a wide area communication network including a public network and a LAN (Local Area Network). The management device 200 is a server device consisting of a computer, for example, and may be a cloud type server. The management device 200 can execute the data communication with various kinds of devices including the portable devices 110, 120 and 130.

The management device 200 includes a sharing DB 210 which stores data regarding a date, time and location of lending the vehicle Vs or the parking location Pa by the owner Uo. Based on the data stored in the sharing DB 210, the user Ur who desires to use an automobile goes through a procedure for borrowing the vehicle Vs by using the portable device 120. In addition, in the information processing system, the user Ur who desires to use the parking location Pa can go through the procedure for borrowing the parking location Pa by using the portable device 130.

The information processing device 1 does not need to be directly connectable to the communication network 500. For example, the information processing device 1 may execute the communication with the portable device 110 by short-range wireless communication means, and may execute the communication with the management device 200 by a function of the portable device 110. In this case, examples of the short-range wireless communication means are Wi-Fi® Direct and Bluetooth®.

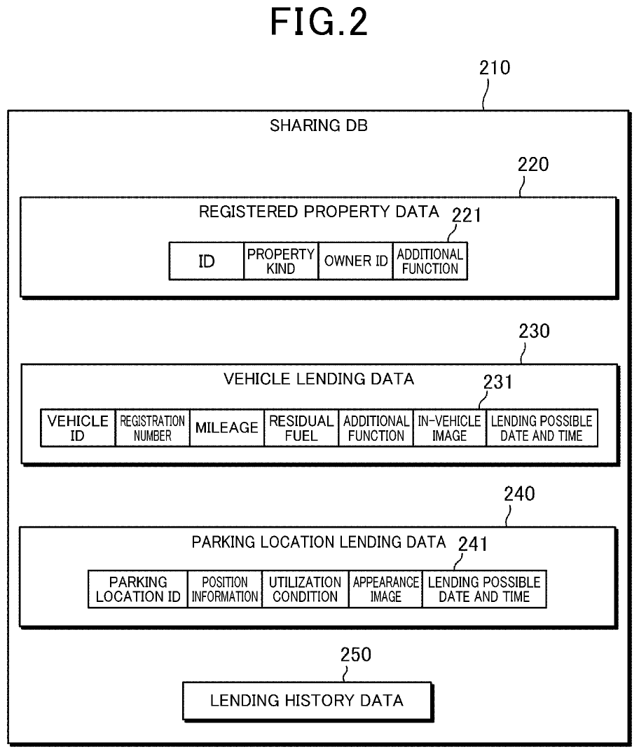

FIG. 2 is a schematic diagram of data stored in the sharing DB 210.

The sharing DB 210 stores registered property data 220, vehicle lending data 230, parking location lending data 240 and lending history data 250.

The registered property data 220 stores a record 221. The record 221 includes, for example, an ID which is identification information of individual property, a kind of the property, an owner ID which is identification information of a property owner, and additional information regarding the property. One record 221 is stored in the registered property data 220 corresponding to one piece of property. The additional information regarding the property is, for example, information regarding additional functions that the vehicle Vs has. A specific example is information indicating whether or not the vehicle Vs has functions of a car navigation device, an automatic driving function, a collision damage reducing brake and an interactive agent or the like. The property for which the record 221 is stored in the registered property data 220 can be lent in the information processing system of the present embodiment.

The vehicle lending data 230 and the parking location lending data 240 store the data of the property registered as the property which can be lent in the information processing system. In other words, the property the data of which is stored in the vehicle lending data 230 or the parking location lending data 240 is the property that the user Ur can borrow. The vehicle lending data 230 includes the data regarding the property corresponding to the vehicle in the property to be lent. The parking location lending data 240 includes the data regarding the property corresponding to the parking location in the property to be lent.

The vehicle lending data 230 includes one record 231 per vehicle to be lent. The record 231 includes, for example, an ID of the vehicle, a registration number, a mileage, residual fuel, the information regarding the additional functions, an in-vehicle image and lending possible date and time. The ID of the vehicle may be in common with the ID in the record 221. The registration number is numbers and symbols of a number plate or a license plate of the vehicle. The mileage and the residual fuel are the total mileage and a fuel residual amount of the vehicle when lending of the vehicle is requested by a method to be described later. The information regarding the additional functions is the information indicating whether or not the vehicle has the functions of a car navigation device, an automatic driving function, a collision damage reducing brake and an interactive agent or the like, similarly to the information included in the record 221. The in-vehicle image is an image of space inside the vehicle photographed when lending of the vehicle is requested. The lending possible date and time specify a start and an end of a period during which the vehicle can be lent. The record 231 may include information indicating a price of lending of the vehicle.

The parking location lending data 240 includes one record 241 per parking location to be lent. The record 241 includes, for example, an ID of the parking location, position information, a utilization condition, an appearance image and the lending possible date and time. The ID of the parking location may be in common with the ID in the record 221. The position information is coordinates indicating the position of the parking location or the like. The utilization condition indicates a condition regarding utilization of the parking location, and is, for example, the information regarding a limit of a size and weight of the vehicle that can be parked. The appearance image is an image in which appearance of the parking location is photographed. The lending possible date and time specify the start and the end of the period during which the parking location can be lent. The record 241 may include the information indicating the price of lending of the parking location.

The lending history data 250 includes data indicating a history of lending of the property by the function of the management device 200. For example, the lending history data 250 includes a lent property ID, the date and time of lending and the date and time of return or the like.

### 2. Configuration of Information Processing Device

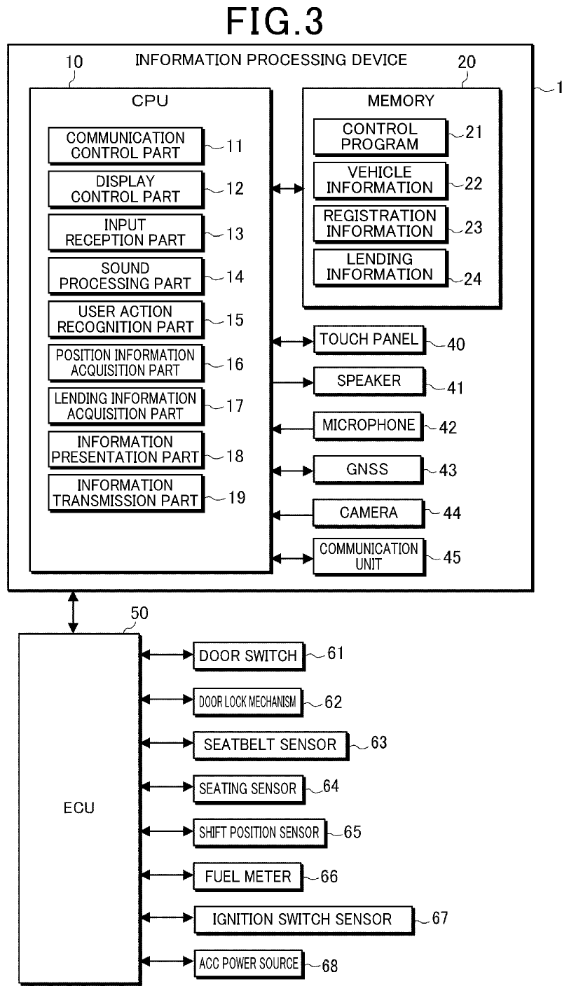

FIG. 3 is a block diagram of the information processing device 1.

The information processing device 1 includes a CPU (Central Processing Unit) 10 (processor) and a memory 20 which stores a program and data. The memory 20 is a storage device configured by a semiconductor memory device or a magnetic recording medium. The memory 20 stores a control program 21 to be executed by the CPU 10 and various kinds of data to be processed by the CPU 10. The CPU 10 controls respective parts of the information processing device 1 by executing the control program 21. The CPU 10 and the memory 20 may include a non-illustrated interface circuit. The memory 20 stores vehicle information 22, registration information 23 and lending information 24. The vehicle information 22 is the information regarding the vehicle Vs, and includes the registration number of the vehicle Vs, a model and the information regarding the additional functions that the vehicle Vs has or the like. The registration information 23 and the lending information 24 will be described later.

FIG. 3 illustrates a communication control part 11, a display control part 12, an input reception part 13, a sound processing part 14, a user action recognition part 15, a position information acquisition part 16, a lending information acquisition part 17, an information presentation part 18 and an information transmission part 19 as functional parts configured by the CPU 10. The individual functional parts are achieved by cooperation of software and hardware by the CPU 10 executing the control program 21. The functions of the individual parts will be described later.

To the CPU 10, the touch panel 40, a speaker 41, a microphone 42, a GNSS (Global Navigation Satellite System) 43, the camera 44 and a communication unit 45 are connected.

The touch panel 40, the speaker 41 and the microphone 42 are, for example, installed on a dashboard of the vehicle Vs. The touch panel 40 is configured such that a liquid crystal display panel which displays characters and images and a touch sensor which detects a touch on the liquid crystal display panel are superimposed. The touch panel 40 corresponds to an example of a display part.

The GNSS 43 has a receiver that receives GNSS signals and detects (measures) a current position of the vehicle Vs based on the GNSS signal. In the case where the vehicle Vs is loaded with a non-illustrated car navigation system, a GPS (Global Positioning System) unit or the like provided in the car navigation system may be utilized as the GNSS 43.

The camera 44 is a digital camera which photographs an interior space of the vehicle Vs. The camera 44 is installed at a front part in the interior of the vehicle Vs or on a ceiling in the interior of the vehicle Vs. The camera 44 may be an omnidirectional (360-degree) camera which photographs all directions or may be a wide angle camera. The camera 44 corresponds to an example of a photographing part.

The communication unit 45 (transceiver/receiver) includes a wireless communication device including an antenna, an RF circuit, an encoder and a decoder or the like. The communication unit 45 is connected to the communication network 500 and executes the data communication with the management device 200. In addition, as described above, the communication unit 45 may perform Wi-Fi Direct or Bluetooth communication with the portable device 110 and be connected to the communication network 500 by utilizing a communication function of the portable device 110. The communication unit 45 corresponds to an example of a communication part.

The information processing device 1 is connected to an ECU (Electronic Control Unit) 50. The ECU 50 is a controller which controls electronic devices loaded in the vehicle Vs. The information processing device 1 is connected to the electronic devices loaded in the vehicle Vs via the ECU 50. FIG. 3 illustrates an example that the information processing device 1 is connected to a door switch 61, a door lock mechanism 62, a seatbelt sensor 63, a seating sensor 64, a shift position sensor 65, a fuel meter 66, an ignition switch sensor 67 and an ACC power source 68 via the ECU 50. The vehicle Vs may be loaded with the plurality of ECUs 50. In this case, the plurality of ECUs 50 may be connected to the information processing device 1.

The door switch 61 is a switch type sensor which detects whether or not a door provided on the vehicle Vs is open. The door switch 61 may be provided only on the door used when a person who drives the vehicle Vs gets in and out. The door lock mechanism 62 locks the door provided on the vehicle Vs in a closed state. In the case where the vehicle Vs includes the plurality of doors, the plurality of door switches 61 and door lock mechanisms 62 may be provided corresponding to the respective doors.

The seatbelt sensor 63 detects a wearing state of a seatbelt provided on a seat of the vehicle Vs. The seating sensor 64 detects whether or not a person is seated on the seat of the vehicle Vs. The seatbelt sensor 63 and the seating sensor 64 may be provided on all the seats provided in the vehicle Vs or may be provided only on a driver's seat.

The shift position sensor 65 detects a shift position of a shift device provided in the vehicle Vs. The shift position is, for example, P (parking) used when parking the vehicle, R (reverse) used when moving backwards, N (neutral), and D (drive) used when traveling. The fuel meter 66 detects the residual amount of the fuel loaded in the vehicle Vs. In the case where the vehicle Vs is an electric automobile, a detection part which detects a battery residual amount may be connected to the information processing device 1 instead of the fuel meter 66. The ignition switch sensor 67 detects a state of an ignition switch or a main switch of the vehicle Vs. The ACC power source (accessory power source) 68 is a power source supplied from a power source circuit provided in the vehicle Vs to the electronic devices and accessories.

The communication control part 11 controls the communication unit 45 and performs the data communication. The communication control part 11 stores the data received by the communication unit 45 in the memory 20.

The display control part 12 outputs a control signal for display to the touch panel 40 and displays a screen including characters and images on the touch panel 40.

The input reception part 13 receives input by a person riding in the vehicle Vs by detecting the operation to the touch panel 40.

The sound processing part 14 acquires digital sound data of sound collected by the microphone 42. In addition, the sound processing part 14 drives the speaker 41 to output the sound.

The user action recognition part 15 recognizes an action of a recognition target person. The recognition target person is a person riding in the vehicle Vs or a person who is to get into the vehicle Vs, and is the owner Uo for example, but may be the user Ur. For details, the user action recognition part 15 recognizes the action of the recognition target person, and detects that the person performs a preset specific action.

In the present embodiment, the specific action includes a specific start action with which it is estimated that the owner Uo is to start moving by the vehicle Vs and a specific get-out action with which it is estimated that the owner Uo is to get out of the vehicle Vs. The user action recognition part 15 detects the specific start action in the case of detecting that (1) the owner Uo gets into the vehicle Vs, (2) the owner Uo starts the vehicle Vs and (3) the owner Uo performs the operation for starting moving by the vehicle Vs, for example.

As a specific example, the user action recognition part 15 detects that the owner Uo has gotten into the vehicle Vs in the case of detecting opening of the door of the vehicle Vs, unlocking of a door lock or seating in the driver's seat. The user action recognition part 15 detects that the owner Uo has started the vehicle Vs in the case of detecting turning-on of the ignition switch or turning-on of the ACC power source 68. The user action recognition part 15 detects that the owner Uo has performed the operation for starting moving in the case of detecting wearing of the seatbelt of the driver's seat or changeover of the shift position of the vehicle Vs from P to D or R. In addition, the user action recognition part 15 may detect that the owner Uo has performed the operation for starting moving by the vehicle Vs in the case of detecting the operation of a steering wheel of the vehicle Vs, entry into a predetermined range of the vehicle Vs of the position information of a portable terminal owned by the owner Uo or activation of the automatic driving function. Further, the user action recognition part 15 may detect that the owner Uo has performed the operation for starting moving by the vehicle Vs in the case where a vehicle speed detected by a vehicle speed sensor of the vehicle Vs becomes greater than 0.

The user action recognition part 15 detects the specific get-off action in the case of detecting that (1) the owner Uo has stopped traveling of the vehicle Vs, (2) the owner Uo has stopped the functions of the vehicle Vs and (3) the owner Uo has gotten out of the vehicle Vs, for example.

As a specific example, the user action recognition part 15 detects that the owner Uo has stopped traveling of the vehicle Vs in the case of detecting release of wearing of the seatbelt of the driver's seat or the changeover of the shift position of the vehicle Vs from D to R or P. In addition, the user action recognition part 15 may detect that the owner Uo has stopped moving by the vehicle Vs in the case of detecting the end of the automatic driving function and in the case where the vehicle speed detected by the vehicle speed sensor of the vehicle Vs becomes 0.

Further, the user action recognition part 15 detects that the owner Uo has stopped the functions of the vehicle Vs in the case of detecting turning-off of the ignition switch or turning-off of the ACC power source 68. The user action recognition part 15 detects that the owner Uo has gotten out of the vehicle Vs in the case of detecting opening of the door after the functions of the vehicle Vs are stopped or unlocking of the door lock after the functions of the vehicle Vs are stopped. In addition, the user action recognition part 15 detects that the owner Uo has gotten out of the vehicle Vs in the case of detecting that the owner Uo has left the driver's seat after the functions of the vehicle Vs are stopped.

The position information acquisition part 16 acquires the position of the vehicle Vs measured by the GNSS 43.

The lending information acquisition part 17 acquires the information from the management device 200. The lending information acquisition part 17 executes the communication with the management device 200 and acquires the record 221 corresponding to the vehicle Vs from the registered property data 220 or collates presence/absence of the record 221 corresponding to the vehicle Vs. Thus, the CPU 10 can determine whether or not the vehicle Vs is registered in the management device 200 as lending target property.

In addition, the lending information acquisition part 17 executes the communication with the management device 200, acquires the lending information 24 extracted from the lending history data 250 and stores the lending information 24 in the memory 20. The lending information 24 is the information indicating the time when the vehicle is lent in lending of the vehicle executed in the past in a predetermined range including the position of the vehicle Vs. The lending information 24 is generated based on the information stored in the lending history data 250 by the management device 200.

The information presentation part 18 presents a setting part for registering the vehicle Vs or the parking location Pa as a lendable state to the owner Uo. The setting part presented by the information presentation part 18 is a user interface for the owner Uo to instruct registration of the vehicle Vs or the parking location Pa as the lendable state. At the user interface, the information regarding lending of the vehicle Vs or the parking location Pa is presented so that the owner Uo can easily give an instruction.

The information transmission part 19 transmits the information to the management device 200 by the communication unit 45. For details, in the case where the owner Uo instructs the registration as the lendable state by utilizing the setting part presented by the information presentation part 18, the information transmission part 19 generates the registration information 23 which requests the registration as the lendable state and transmits the registration information 23 to the management device 200.

In the case where the vehicle Vs registered as the lendable state starts moving while being registered as the lendable state, the information transmission part 19 transmits cancellation information which cancels the registration of the vehicle Vs as the lendable state to the management device 200. For example, when the user action recognition part 15 detects the specific start action of the owner Uo, the information transmission part 19 refers to the registration information 23 and determines whether or not it is a time period during which the vehicle Vs is in the lendable state. In the case where it is the time period during which the vehicle Vs is in the lendable state, the information transmission part 19 transmits the cancellation information to the management device 200.

### 3. Operation of Information Processing Device and Management Device

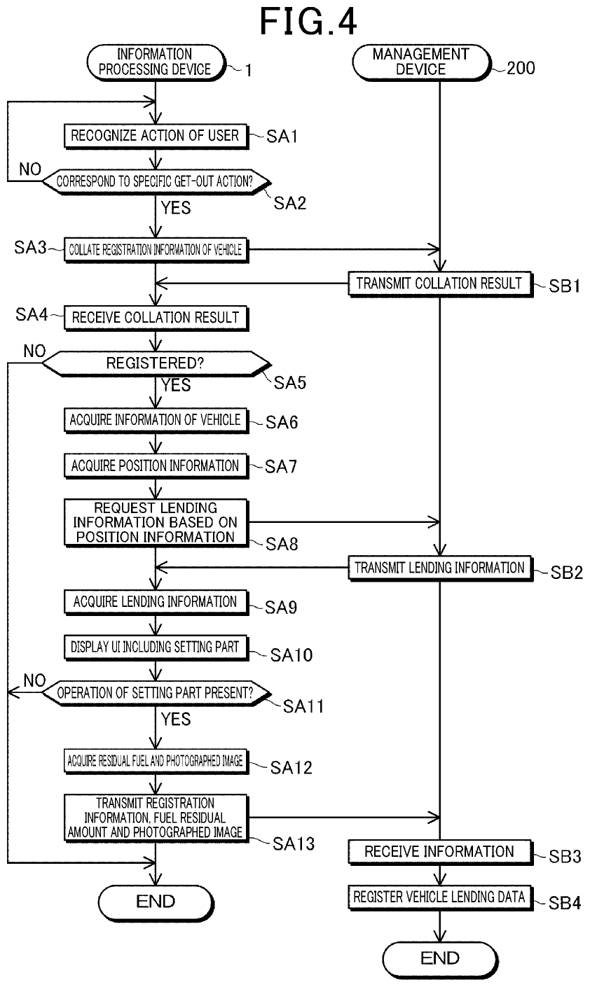

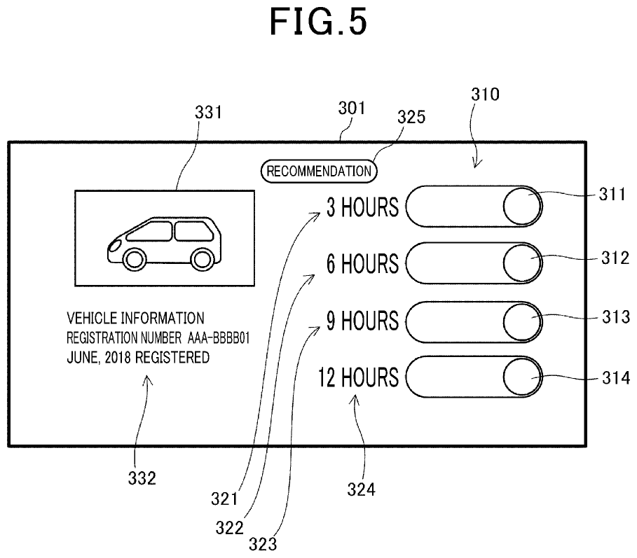

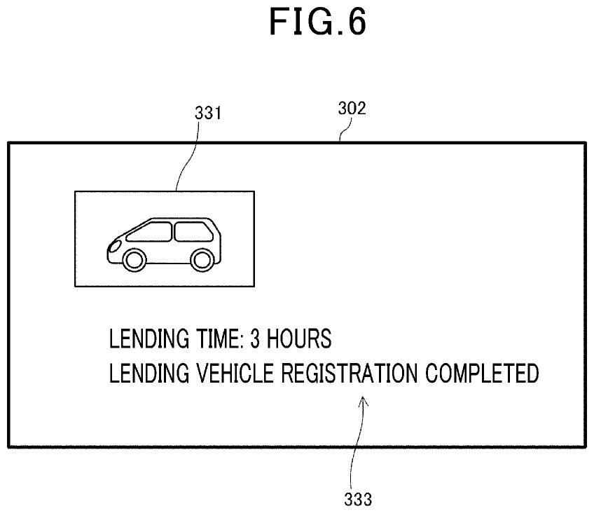

FIG. 4 is a sequence diagram illustrating the outline of the operation of the information processing device 1 and the management device 200. FIG. 4 illustrates the operation of the information processing device 1 and the management device 200 respectively. FIG. 5 and FIG. 6 are diagrams illustrating an example of the screen displayed by the information processing device 1. Hereinafter, the operation of the information processing device 1 and the management device 200 will be described with reference to FIG. 4, FIG. 5 and FIG. 6.

Of the operation of the information processing device 1, steps SA1 and SA2 are executed by the user action recognition part 15 and steps SA3, SA4, SA5, SA8 and SA9 are executed by the lending information acquisition part 17. Steps SA6 and SA7 are executed by the position information acquisition part 16 and step SA10 is executed by the information presentation part 18. Steps SA11 to SA13 are executed by the information transmission part 19.

The operation illustrated in FIG. 4 is executed when the owner Uo is present inside the vehicle Vs while the vehicle Vs is traveling and while the vehicle Vs is stopped.

The information processing device 1 recognizes the action of the owner Uo (step SA1) and determines whether or not the action of the owner Uo corresponds to the specific get-out action (step SA2). That is, the information processing device 1 detects the specific get-out action of the owner Uo.

In the case of determining that the action of the owner Uo does not correspond to the specific get-out action (step SA2; NO), the information processing device 1 returns to step SA1.

In the case of determining that the action of the owner Uo corresponds to the specific get-out action (step SA2; YES), the information processing device 1 collates whether or not the vehicle Vs is registered in the management device 200 as the lending target property (step SA3). In step SA3, the information processing device 1 transmits the information such as the registration number of the vehicle Vs to the management device 200 and inquires whether or not the record 221 corresponding to the vehicle Vs is stored in the registered property data 220.

In response to an inquiry of the information processing device 1, the management device 200 transmits a collation result indicating whether or not the record 221 corresponding to the vehicle Vs is stored in the registered property data 220 to the information processing device 1 (step SB1).

The information processing device 1 receives the collation result from the management device 200 (step SA4) and determines whether or not the vehicle Vs is registered based on the collation result (step SA5). In the case of determining that the vehicle Vs is not registered in the management device 200 (step SA5; NO), the information processing device 1 ends the present processing.

In the case of determining that the vehicle Vs is registered in the management device 200 (step SA5; YES), the information processing device 1 reads and acquires the vehicle information 22 from the memory 20 (step SA6). The information processing device 1 acquires the position information from the GNSS 43 (step SA7) and requests the lending information 24 based on the position information of the vehicle Vs to the management device 200 (step SA8).

In response to the request of the information processing device 1, the management device 200 generates the lending information 24 and transmits the lending information 24 to the information processing device 1 (step SB2). In step SB2, the management device 200 extracts the information regarding lending of the vehicle executed in the past in the predetermined range including the position of the vehicle Vs from the lending history data 250. Further, the management device 200 extracts the information indicating the time when the vehicle is lent from the extracted information and calculates average lending time. The management device 200 generates the lending information 24 including the calculated lending time average.

The information processing device 1 acquires the lending information 24 transmitted by the management device 200 and stores the lending information 24 in the memory 20 (step SA9).

The information processing device 1 displays the user interface (UI) including the setting part on the touch panel 40 based on the lending information 24 (step SA10).

FIG. 5 is a diagram illustrating a car sharing setting screen 301 as an example of the screen displayed by the information processing device 1.

The car sharing setting screen 301 is the user interface which presents the information to the owner Uo and receives the operation by the owner Uo.

The car sharing setting screen 301 includes a setting part 310. At the setting part 310, car sharing buttons 311, 312, 313 and 314 are arranged. Lending time displays 321, 322, 323 and 324 are arranged corresponding to the individual car sharing buttons 311, 312, 313 and 314.

The car sharing buttons 311, 312, 313 and 314 are operation parts for instructing the registration of the vehicle Vs as the lendable state by the owner Uo. For example, the car sharing button 311 receives the operation of touching the car sharing button 311 by the owner Uo. The operation is detected by the touch sensor provided in the touch panel 40. The car sharing buttons 312, 313 and 314 are similar.

The car sharing button 311 is the operation which instructs the registration of the vehicle Vs as the lendable state for the time displayed at the lending time display 321. Similarly, the car sharing buttons 312, 313 and 314 are the operation parts which instruct the registration of the vehicle Vs as the lendable state for the time displayed at the lending time displays 322, 323 and 324.

The time displayed at the lending time displays 321, 322, 323 and 324 are candidates of the lending time proposed by the information processing device 1 to the owner Uo. There may be one lending time candidate and there may be the plurality of lending time candidates as illustrated in FIG. 5. The lending time candidates are generated based on the lending information 24. That is, the information processing device 1 presents the candidates of the time to lend the vehicle Vs to the owner Uo based on a result of lending of the vehicle executed in the past around the vehicle Vs. The owner Uo selects the lending time candidate displayed on the car sharing setting screen 301 and performs the operation at the setting part 310. Thus, the vehicle Vs can be put in the lendable state for the time convenient for the user Ur who desires to borrow the vehicle and the lending time beneficial for both of the owner Uo and the user Ur can be set.

The car sharing setting screen 301 includes a recommendation marker 325. The recommendation marker 325 is the display which increases an attention degree of the lending time displays 321, 322, 323 and 324. The recommendation marker 325 is arranged corresponding to the lending time candidate estimated to be in highest demand based on the lending information 24. In the example in FIG. 5, the recommendation marker 325 is arranged beside the lending time display 321. By displaying the recommendation marker 325 and emphasizing one of the lending time candidates, the lending time with which it is easy to establish a lending contract of the vehicle Vs can be recommended to the owner Uo.

On the car sharing setting screen 301, a vehicle image 331 and vehicle information 332 are arranged. The vehicle image 331 is the image of the vehicle Vs. The vehicle information 332 is the information regarding the vehicle Vs and includes the registration number for example. The vehicle image 331 and the vehicle information 332 are included in the vehicle information 22. The vehicle image 331 and the vehicle information 332 are effective in making the owner Uo confirm that a target to be registered as the lendable state is the vehicle Vs.

The information processing device 1 determines the presence/absence of the operation to the setting part (step SA11), and ends the present processing in the case where there is no operation for a predetermined period of time or longer (step SA11; NO).

In the case where there is the operation to the setting part (step SA11; YES), the information processing device 1 acquires the fuel residual amount and a photographed image of the camera 44 (step SA12). In step SA12, the fuel residual amount after the operation to the setting part and the photographed image photographed by the camera 44 after the operation are acquired. Here, in the case where the operation of the fuel meter 66 is stopped by turning-off of the ignition switch or the ACC power source 68, the information processing device 1 acquires the fuel residual amount detected last by the fuel meter 66.

The information processing device 1 transmits the registration information which requests the registration of the vehicle Vs as the lendable state, the fuel residual amount and the photographed image to the management device 200 (step SA13). The registration information includes the lending time to put the vehicle Vs in the lendable state. The lending time is the time specified by the operation of the setting part.

The management device 200 receives the registration information, the fuel residual amount and the photographed image from the information processing device 1 (step SB3). The management device 200 generates the record 231 of the vehicle lending data 230 based on the information received in step SB3 and registers the vehicle Vs as the lendable state (step SB4).

FIG. 6 is a diagram illustrating a registration completion notification screen 302 as an example of the screen displayed by the information processing device 1.

The registration completion notification screen 302 is the screen which notifies the owner Uo of completion of the registration as the lendable state after the operation to the setting part 310 on the car sharing setting screen 301 is performed, and is displayed on the touch panel 40.

On the registration completion notification screen 302, the vehicle image 331 and a registration completion notice 333 are arranged. The vehicle image 331 is in common with the car sharing setting screen 301. The registration completion notice 333 includes characters and images that notify the owner Uo of the completion of the registration of the vehicle Vs as the lendable state and the lending time set to the lendable state.

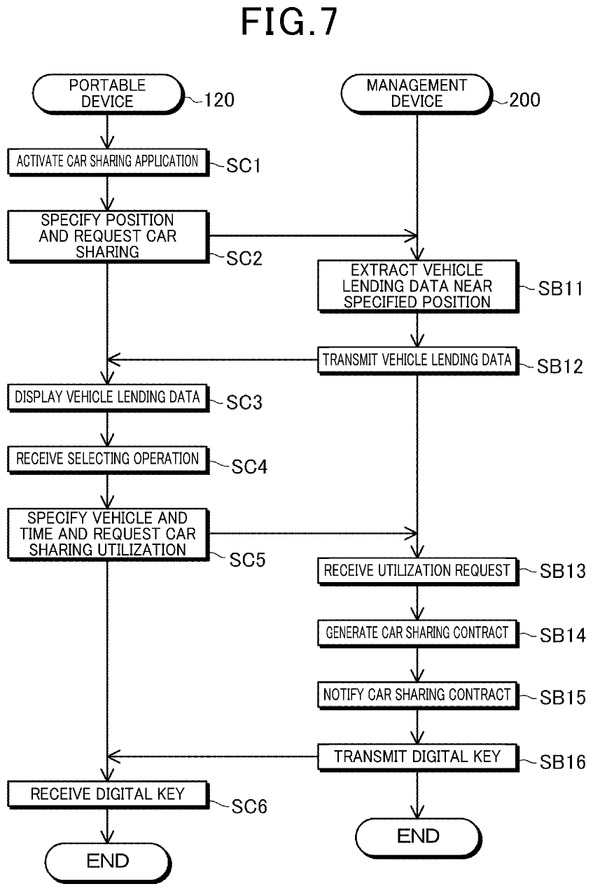

Here, the procedure of the user Ur for borrowing the vehicle Vs registered as the lendable state will be described. FIG. 7 is a sequence diagram illustrating the operation of the portable device 120 and the management device 200.

The portable device 120 activates an application program (hereinafter referred to as an app) in response to the operation of the user Ur (step SC1). The app is an app for the user Ur to utilize a vehicle sharing service, so-called car sharing, provided by the management device 200.

The portable device 120 specifies the position and requests utilization of car sharing, in response to the operation of the user Ur (step SC2). Specifically, the portable device 120 requests the information of the vehicle that can be borrowed at a utilization location desired by the user Ur to the management device 200.

In response to the request of the portable device 120, the management device 200 extracts the record 231 from the vehicle lending data 230 (step SB11). In step SB11, the management device 200 extracts the record 231 of the vehicle in the lendable state at or near the location specified by the portable device 120 from the vehicle lending data 230. The management device 200 transmits the data extracted from the vehicle lending data 230 to the portable device 120 (step SB12). In step SB12, the management device 200 may exclude the information regarding the owner Uo or the like from the information included in the record 231 extracted from the vehicle lending data 230 and perform transmission to the portable device 120.

The portable device 120 receives the data transmitted by the management device 200 and displays the data on a display screen (step SC3). For example, the portable device 120 displays the information of the vehicle that can be borrowed, the position where the vehicle can be borrowed and the lending time of the vehicle or the like. Examples of the information of the vehicle are a vehicle type, the additional functions, the fuel residual amount and the photographed image of the vehicle.

When the user Ur performs the operation of selecting the vehicle desired to be utilized or the like based on the displayed information, the portable device 120 receives the operation of the user Ur (step SC4). The portable device 120 specifies the vehicle desired to be borrowed and the using time of the vehicle and requests the utilization of car sharing to the management device 200 (step SC5).

The management device 200 receives the request by the portable device 120 (step SB13), generates a car sharing contract and stores the information relating to the contract in the lending history data 250 (step SB14). The management device 200 notifies the portable device 120 and the portable device 110 used by the owner Uo of the target vehicle of establishment of the car sharing contract (step SB15). The management device 200 issues a digital key for unlocking a lock of the vehicle Vs to be utilized to the portable device 120 (step SB16).

The portable device 120 receives the digital key from the management device 200 (step SC6).

In this way, the vehicle registered as the lendable state in the management device 200 is lent according to the request of the user Ur who desires to utilize the vehicle. In the operation illustrated in FIG. 7, processing of billing and settling a charge to the user Ur may be performed. In addition, the digital key may be issued to the portable device 120 by a server device different from the management device 200.

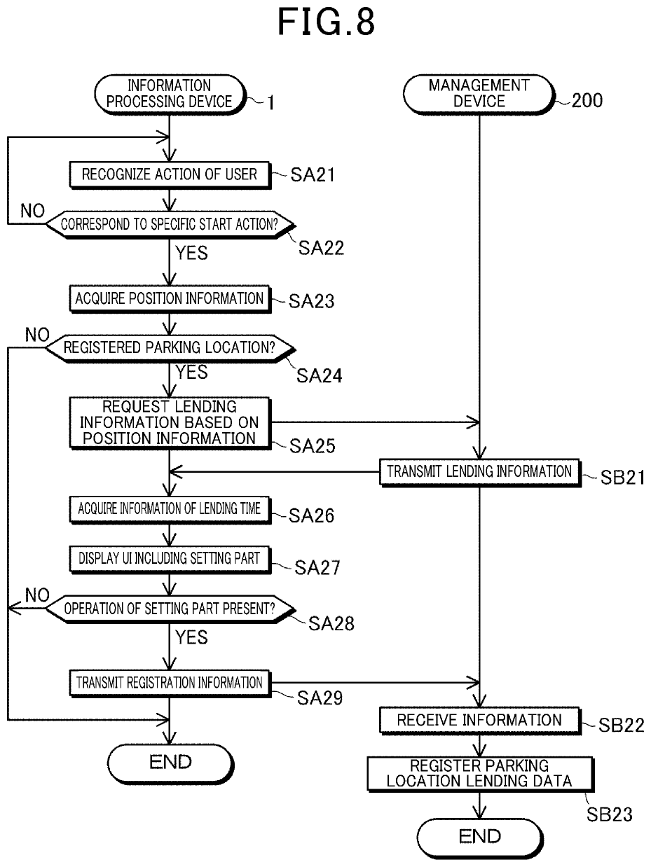

FIG. 8 is a sequence diagram illustrating the outline of the operation of the information processing device 1 and the management device 200. The operation of registering the parking location Pa as the lendable state will be described with reference to FIG. 8.

Of the operation of the information processing device 1, steps SA21 and SA22 are executed by the user action recognition part 15 and steps SA25 and SA26 are executed by the lending information acquisition part 17. Steps SA23 and SA24 are executed by the position information acquisition part 16 and step SA27 is executed by the information presentation part 18. Steps SA28 and SA29 are executed by the information transmission part 19.

The operation illustrated in FIG. 8 is executed while the vehicle Vs is stopped and while the vehicle Vs is parked.

The information processing device 1 recognizes the action of the owner Uo (step SA21) and determines whether or not the action of the owner Uo corresponds to the specific start action (step SA22). That is, the information processing device 1 detects the specific start action of the owner Uo.

In the case of determining that the action of the owner Uo does not correspond to the specific start action (step SA22; NO), the information processing device 1 returns to step SA21.

In the case of determining that the action of the owner Uo corresponds to the specific start action (step SA22; YES), the information processing device 1 acquires the position information by the GNSS 43 (step SA23). The information processing device 1 determines whether or not the position of the vehicle Vs is the parking location registered as the property to be lent by the owner Uo (step SA24). In the case where the position of the vehicle Vs is not the registered parking location (step SA24; NO), the information processing device 1 ends the processing.

In the case where the position of the vehicle Vs is the registered parking location (step SA24; YES), the information processing device 1 requests the lending information 24 based on the position information of the vehicle Vs to the management device 200 (step SA25).

The management device 200 generates the lending information 24 in response to the request of the information processing device 1 (step SB21). In step SB21, the management device 200 extracts the information regarding lending of the parking location executed in the past in the predetermined range including the position of the vehicle Vs from the lending history data 250. Further, the management device 200 extracts the information indicating the time when the parking location is lent from the extracted information and calculates the lending time average. The management device 200 generates the lending information 24 including the calculated lending time average and transmits the lending information 24 to the information processing device 1.

The information processing device 1 acquires the lending information 24 transmitted by the management device 200 and stores the lending information 24 in the memory 20 (step SA26).

The information processing device 1 displays the user interface including the setting part on the touch panel 40 based on the lending information 24 (step SA27).

The user interface displayed in step SA27 includes the setting part which instructs lending of the parking location Pa similarly to the car sharing setting screen 301, for example, and can specify the lending time.

The information processing device 1 determines the presence/absence of the operation to the setting part (step SA28), and ends the present processing in the case where there is no operation for the predetermined period of time or longer (step SA28; NO).

In the case where there is the operation to the setting part (step SA28; YES), the information processing device 1 transmits the registration information which requests the registration of the parking location Pa as the lendable state to the management device 200 (step SA29). The registration information includes the lending time to put the parking location Pa in the lendable state. The lending time is the time specified by the operation of the setting part.

The management device 200 receives the registration information from the information processing device 1 (step SB22). The management device 200 generates the record 241 of the parking location lending data 240 based on the information received in step SB22 and registers the parking location Pa as the lendable state (step SB23).

### 4. Other Embodiments

The embodiment described above illustrates a specific example to which the present invention is applied and does not limit the form to which the invention is applied.

For example, while the above-described embodiment has illustrated a four-wheel automobile as an example of the vehicle Vs, the vehicle Vs can be various vehicles such as a two-wheel vehicle and a freight vehicle.

In addition, in the above-described embodiment, the information processing device 1 has been described as the one that displays the user interface including the setting part on the touch panel 40 and receives the touch operation to the touch panel 40. This is an example, and the information processing device 1 may display the user interface on the touch panel 40 and then receive the operation by sound by utilizing the microphone 42 for example. Further, the configuration may be such that selection of the lending time and the registration as the lendable state are guided by outputting the sound by the speaker 41.

In addition, the information processing device 1 is not limited to the one fixedly installed in the vehicle Vs. That is, when the touch panel 40 which is a device to present the user interface and the camera 44 which performs photographing are installed in the vehicle Vs, the other configuration can be arbitrarily changed. For example, part of the operation executed by the CPU 10 of the information processing device 1 described in the above-described embodiment may be achieved by a device similar to the portable device 110.

Note that FIG. 3 is a schematic diagram in which the functional configuration of the information processing device 1 is sectioned by main processing contents and illustrated in order to facilitate understanding of the present claimed invention, and does not limit the configuration of the information processing device 1. For example, the processing of the components provided in the CPU 10 may be executed by one hardware unit, or may be executed by a plurality of hardware units.

In addition, the individual processing illustrated in FIG. 4, FIG. 7 and FIG. 8 may be executed by one program, or may be executed by a plurality of programs.

Further, the control program 21 executed by the CPU 10 can be achieved in the state of recording the control program 21 in a portable information recording medium. The examples of the information recording medium are a magnetic recording medium such as a hard disk, an optical recording medium such as a CD and a semiconductor storage device such as an USB (Universal Serial Bus) memory and an SSD (Solid State Drive), and the other recording media can be also used. The information processing device 1 may read the control program 21 from the information recording medium and execute the control program 21.

### 5. Configuration Supported by Above-Described Embodiment

The above-described embodiment is a specific example of the configuration below.

(Item 1) An information processing device including: a user action recognition part configured to recognize an action of a user of a moving body; an information presentation part configured to present a setting part which registers property of the user as a lendable state, to the user, in a case where a specific action corresponding to either of an action with which it is estimated that the user is to start moving by the moving body or an action with which it is estimated that the user is to get out of the moving body is recognized by the user action recognition part; a communication part configured to communicate with a management device; and an information transmission part configured to transmit registration information which registers the property as the lendable state by the communication part in the case where registration is instructed by the setting part.

According to the information processing device of Item 1, in the case where the action with which it is estimated that the user is to start moving by the moving body or the action with which it is estimated that the user is to get out of the moving body is performed, lending of the property can be registered by utilizing the setting part. Therefore, since the user can easily register lending of the property, a procedure regarding lending of the property can be simplified and convenience can be improved. Further, the information processing device presents the setting part when it is estimated that lending of the property becomes possible by recognizing the specific action of the user. Thus, the user can easily register lending without scheduling lending of the property. In addition, even the case where a schedule of the user is uncertain can be coped with.

(Item 2) The information processing device according to Item 1, wherein the information presentation part presents time to put the property in the lendable state when presenting the setting part.

According to the information processing device of Item 2, the time to put the property in the lendable state can be easily registered by utilizing the setting part.

(Item 3) The information processing device according to Item 2, wherein the information presentation part presents a plurality of candidates of the time to put the property in the lendable state when presenting the setting part.

According to the information processing device of Item 3, the time to put the property in the lendable state can be more easily registered by referring to the candidates presented together with the setting part.

(Item 4) The information processing device according to any one of Items 1 to 3, including a position information acquisition part configured to acquire a position of the moving body, wherein the information presentation part presents the setting part in the case where the position of the moving body acquired by the position information acquisition part is a specific position set beforehand.

According to the information processing device of Item 4, since the setting part is presented in the case where it is estimated that lending of the property becomes possible with high certainty, presentation of the setting part at a timing when the setting part is not needed can be suppressed. Thus, the convenience of the user can be improved further.

(Item 5) The information processing device according to Item 2 or 3, including: a position information acquisition part configured to acquire a position of the moving body; and a lending information acquisition part configured to acquire information regarding a lending situation of property of a same kind as the property based on the position of the moving body from the management device, wherein the information presentation part presents the time to put the property in the lendable state based on the information acquired by the lending information acquisition part, when presenting the setting part.

According to the information processing device of Item 5, the time to put the property in the lendable state is presented based on the lending situation of the property of the same kind as the property of the user. Thus, the property of the user can be put in the lendable state for the time convenient for the utilization by a third person who borrows the property and the property can be efficiently utilized.

(Item 6) The information processing device according to any one of Items 1 to 5, wherein the user action recognition part recognizes the action of the user based on at least one of a power supply state of apparatuses loaded in the moving body, an open/closed state of a door provided on the moving body, a lock state of the door and a seating state on a seat of the moving body.

According to the information processing device of Item 6, the specific action of the user can be highly accurately recognized based on the state of the moving body.

(Item 7) The information processing device according to any one of Items 1 to 6, wherein the property is the moving body, and the information transmission part transmits the registration information and information indicating a residual amount of fuel that the moving body has by the communication part.

According to the information processing device of Item 7, in the case of registering the moving body as the lendable state as the property, the information indicating the residual amount of the fuel of the moving body can be managed by the management device. Thus, the third person who borrows the property can recognize the residual amount of the fuel and the convenience of the third person who borrows the property can be improved.

(Item 8) The information processing device according to any one of Items 1 to 7, wherein the property is the moving body, the information processing device includes a photographing part configured to photograph the moving body, and the information transmission part transmits the registration information and a photographed image of the photographing part by the communication part.

According to the information processing device of Item 8, in the case of registering the moving body as the lendable state as the property, the image in which the moving body is photographed can be managed by the management device. Thus, the third person who borrows the property can view the image in which the moving body is photographed and the convenience of the third person who borrows the property can be improved.

(Item 9) The information processing device according to any one of Items 1 to 8, wherein the information transmission part transmits cancellation information which cancels registration of the property as the lendable state by the communication part in the case where the property registered as the lendable state is the moving body and the moving body starts moving while being registered as the lendable state.

According to the information processing device of Item 9, the lendable state can be canceled in the case where the moving body is registered as the lendable state and in the case where a possibility that the moving body cannot be lent occurs. Thus, in the case where the schedule of the user is changed after the moving body is registered as the lendable state, the registration as the lendable state can be promptly canceled.

(Item 10) The information processing device according to any one of Items 1 to 9, wherein the information presentation part presents the setting part by a display part provided in the moving body, and the information transmission part transmits the registration information by the communication part based on an operation to the setting part displayed at the display part.

According to the information processing device of Item 10, the user can easily register lending of the property by utilizing the display part provided in the moving body.

(Item 11) An information processing method that recognizes an action of a user of a moving body, presents a setting part which registers property of the user as a lendable state, to the user, in a case where a specific action corresponding to either of an action with which it is estimated that the user is to start moving by the moving body or an action with which it is estimated that the user is to get out of the moving body is recognized, and transmits registration information which registers the property as the lendable state to a management device in the case where registration is instructed by the setting part.

According to the information processing method of Item 11, in the case where the action with which it is estimated that the user is to start moving by the moving body or the action with which it is estimated that the user is to get out of the moving body is performed, lending of the property can be registered by utilizing the setting part. Therefore, since the user can easily register lending of the property, a procedure regarding lending of the property can be simplified and the convenience can be improved. Further, the information processing device presents the setting part when it is estimated that lending of the property becomes possible by recognizing the specific action of the user. Thus, the user can easily register lending without scheduling lending of the property. In addition, even the case where the schedule of the user is uncertain can be coped with.

(Item 12) A non-transitory computer-readable recording medium having a program executable by a computer that controls an information processing device including a communication part recorded thereon, the recording medium having the program for, by the computer, recognizing an action of a user of a moving body, presenting a setting part which registers property of the user as a lendable state, to the user, in a case where a specific action corresponding to either of an action with which it is estimated that the user is to start moving by the moving body or an action with which it is estimated that the user is to get out of the moving body is recognized, and transmitting registration information which registers the property as the lendable state to a management device by the communication part in the case where registration is instructed by the setting part, recorded thereon.

According to a program of Item 12, in the case where the action with which it is estimated that the user is to start moving by the moving body or the action with which it is estimated that the user is to get out of the moving body is performed, lending of the property can be registered by utilizing the setting part. Therefore, since the user can easily register lending of the property, a procedure regarding lending of the property can be simplified and the convenience can be improved. Further, the information processing device presents the setting part when it is estimated that lending of the property becomes possible by recognizing the specific action of the user. Thus, the user can easily register lending without scheduling lending of the property. In addition, even the case where the schedule of the user is uncertain can be coped with.

1 . . . information processing device, 10 . . . CPU, 11 . . . communication control part, 13 . . . input reception part, 14 . . . sound processing part, 15 . . . user action recognition part, 16 . . . position information acquisition part, 17 . . . lending information acquisition part, 18 . . . information presentation part, 19 . . . information transmission part, 20 . . . memory, 21 . . . control program (program), 22 . . . vehicle information, 23 . . . registration information, 24 . . . lending information, 40 . . . touch panel (display part), 41 . . . speaker, 42 . . . microphone, 43 . . . GNSS, 44 . . . camera (photographing part), 45 . . . communication unit (communication part), 110, 120, 130 . . . portable device, 200 . . . management device (management server), 301 . . . car sharing setting screen, 310 . . . setting part (user interface), 500 . . . communication network, Pa . . . parking location, Uo . . . owner (user), Vs . . . vehicle (moving body).

What is claimed is:

1. An information processing device comprising a processor that:
recognizes an action of a user of a moving body;
presents a user interface which registers property of the user as a lendable state, to the user, in a case where a specific action corresponding to either of an action with which it is estimated that the user is to start moving by the moving body or an action with which it is estimated that the user is to get out of the moving body is recognized;
communicates with a management server; and
transmits registration information which registers the property as the lendable state in a case where registration is instructed.

2. The information processing device according to claim 1, wherein the processor presents time to put the property in the lendable state when presenting the user interface.

3. The information processing device according to claim 2, wherein the processor presents a plurality of candidates of the time to put the property in the lendable state when presenting the user interface.

4. The information processing device according to claim 1, wherein the processor:
acquires a position of the moving body; and
presents the user interface in a case where the position of the moving body acquired is a specific position set beforehand.

5. The information processing device according to claim 2, wherein the processor:
acquires a position of the moving body; and
acquires information regarding a lending situation of property of a same kind as the property based on the position of the moving body from the management server,
wherein the processor presents the time to put the property in the lendable state based on the information acquired, when presenting the user interface.

6. The information processing device according to claim 1, wherein the processor recognizes the action of the user based on at least one of a power supply state of apparatuses loaded in the moving body, an open/closed state of a door provided on the moving body, a lock state of the door and a seating state on a seat of the moving body.

7. The information processing device according to claim 1,
wherein the property is the moving body, and
the processor transmits the registration information and information indicating a residual amount of fuel that the moving body has.

8. The information processing device according to claim 1,
wherein the property is the moving body,
the information processing device comprises a camera configured to photograph the moving body, and
the processor transmits the registration information and a photographed image of the camera.

9. The information processing device according to claim 1, wherein the processor transmits cancellation information which cancels registration of the property as the lendable state in a case where the property registered as the lendable state is the moving body and the moving body starts moving while being registered as the lendable state.

10. The information processing device according to claim 1,
wherein the processor presents the user interface by a display provided in the moving body, and
the processor transmits the registration information based on an operation to the user interface displayed at the display.

11. An information processing method that
recognizes an action of a user of a moving body,
presents a user interface which registers property of the user as a lendable state, to the user, in a case where a specific action corresponding to either of an action with which it is estimated that the user is to start moving by the moving body or an action with which it is estimated that the user is to get out of the moving body is recognized, and
transmits registration information which registers the property as the lendable state to a management server in the case where registration is instructed by the user interface.

12. A non-transitory computer-readable recording medium having a program executable by a computer that controls an information processing device including a transceiver and a receiver recorded thereon, the recording medium having the program for,
by the computer,
recognizing an action of a user of a moving body,
presenting a user interface which registers property of the user as a lendable state, to the user, in a case where a specific action corresponding to either of an action with which it is estimated that the user is to start moving by the moving body or an action with which it is estimated that the user is to get out of the moving body is recognized, and
transmitting registration information which registers the property as the lendable state to a management server by the transceiver in the case where registration is instructed by the user interface,
recorded thereon.
